(19) United States
(12) Patent Application Publication
(10) Pub. No.: US 2008/0042310 A1
(43) Pub. Date: Feb. 21, 2008

(54) Magnetic mold closure

(76) Inventor: William Davis, Morris, PA (US)

Correspondence Address: L. ZALE PATENT LAW OFFICE, 334 SOUTH FRANKLIN ST., WILKES-BARRE, PA, 18702, US

(21) Appl. No.: 11/891,736

(22) Filed: Aug. 13, 2007

Related U.S. Application Data
(60) Provisional application No. 60/838,962, filed on Aug. 18, 2006.

(51) Int. Cl. B29C 39/44

(52) U.S. Cl. 264/40.5; 425/143

(57) ABSTRACT

A magnetic mold closure system [1000] employs at least two mold parts [1110, 1120] having at least one solenoid (1300, 1400). A bidirectional power controller [1500] provides current to a plurality of electromagnetic solenoids [1300, 1400] to precisely hold the mold parts [1110, 1120] together. This attraction effectively automates the closing of the mold closure, so as to begin the casting process. Upon curing of the material to a point where it can be removed from the mold parts [1110, 1120], a logic unit [1200] determines when to open the mold closure [1100]. The bidirectional power controller [1500] applies current in a reverse direction to provide a repelling force which automates the opening of the mold closure [1100]. This automated approach to the molding will reduce cycle times and waste while providing a more ergonomic and safe environment for the operator of the mold closure.

### CROSS REFERENCE TO RELATED APPLICATIONS

This application claims priority from U.S. Provisional Patent Application 60/838,962 filed Aug. 18, 2006 and hereby incorporates it by reference as if it were set forth in its entirety herein.

### BACKGROUND OF THE INVENTION

1. Field of the Invention

The present invention relates to a mold closure system employed in the manufacturing process.

2. Discussion of Related Art

Prior art systems exist for the manufacturing technique used in the forming of objects from materials which harden into solid shapes. The materials are introduced into a mold to form a cast of a desired shape, which is the inverse of the mold, then removed to produce the desired object. The casting can be made from any liquid material which hardens into a solid material. Typically, the material may be a multi-component material which includes a hardener to cure and hardens the material, or it may be a material which is liquid at high temperatures and hardens as it cools.

The given material is introduced into the mold closure in its liquid state. Since the hardened piece must be removed, the mold closure is allowed to be disassembled to allow the solid object to be removed.

Typically, the parts of the mold are held together by a number of attachments such as a screw and washer assembly, clamps or vice grips. The liquid material within the mold closure is then allowed to set, in which the materials begin the crystallization process to form a solid object of the shape of the inside of the mold. Upon solidification of the object the mold closure is opened by releasing the attachment means. The set object is now able to be removed as a solid object from the mold closure.

After the mold is filled, sometimes liquid which escapes into the cracks between the mold pieces hardens into imperfections called flashing.

After the object is removed from the mold, it is checked for imperfections such as misshaping and flashing. The larger the spacing between the mold pieces, the greater the amount of flashing.

Improper closure due to the attachment means closing with varying amounts of force at different locations where the mold parts meet, causes additional imperfections.

This problem is a function of the system(s) used to close existing mold closures. Imprecise or non-uniform closing of the mold closure results in additional flashing. The flashing may be removed but is typically done manually and is time-consuming.

Currently, there is a need for a more accurate mold closure system which can be employed in the manufacturing process of shaping materials in a more precise manner by creating a more uniform seal between mold pieces.

### SUMMARY OF THE INVENTION

One embodiment of the present invention is a mold closure 1100 for curing liquid materials into objects in said enclosure comprising:
a) at least two mold parts 1110, 1120 each having a mating edge 1113, 1123 which are designed to fit together;
b) At least one electromagnetic solenoid 1300, 1400 on a mold part 1110, 1120 that produces a magnetic field attracting or repelling at least one other mold part 1110, 1120 when provided with an electric current;
c) a logic unit 1200 for determining what forces should be exerted by each solenoid;
d) a bidirectional power controller 1500 responsive to the logic unit 1200 for providing current to the solenoids to provide the force determined by the logic unit 1200 to each of the solenoids.
   It may also include:
a viscosity sensor for measuring viscosity of said material and the logic unit is further adapted to cause the solenoids to attract the other mold part with greater force when the material is less viscous as compared to when the material is more viscous.
   It may also include:
a) a temperature recorder to keep track of the temperature of the material over time, and
b) an integrator which integrates the temperature over time to estimate when the material has cured.

### OBJECTS OF THE INVENTION

It is an object of the present invention to provide a system which is magnetically automated to open and close multi-piece molds.

It is another object of the present invention to provide a system which is magnetically automated to precisely create a uniform seal between multiple parts of a mold where the mold parts meet.

It is another object of the present invention to provide a system which is magnetically automated to provide a uniform seal between mold parts of a multi-part mold so as to reduce the time it takes to make a molded part.

It is another object of the present invention to provide a system which is magnetically automated to provide a uniform seal between mold parts of a multi-part mold so as to reduce the waste in making a molded part.

It is another object of the present invention to provide a system which is magnetically automated to provide a uniform seal between mold parts of a multi-part mold so as to make manufacture of a molded part easier for a mold worker.

It is another object of the present invention to precisely measure when liquid in a mold has cured and release the cured material shortly after it has cured to minimize sticking.

It is another object of the present invention to provide an energy efficient mold system.

### BRIEF DESCRIPTION OF THE DRAWINGS

The advantages of this disclosure will become more apparent when read with the specification and the drawings, wherein:

FIG. 1 is a perspective overall view of one embodiment of a magnetic mold enclosure according to the present invention.

FIG. 2 is a perspective overall view of a second embodiment of a magnetic mold enclosure according to the present invention.

FIG. 3 is an enlarged perspective view of a solenoid of FIGS. 1, 2 according to one embodiment of the present invention.

FIG. 4 is an enlarged view of a cross section of an alternative embodiment of the present invention.

### DETAILED DESCRIPTION OF THE INVENTION

When using multi-part molds to create a solid molded part from liquid materials, the mold parts must be held together accurately, to provide proper casting conditions. Due to the conditions of certain processes, mechanical clamps have been used to keep mold parts together. However, as stated above using mechanical clamps are time-consuming to apply and provide poor pressure uniformity around the mold, resulting in improper molding and excessive flashing.

These non-automated methods of mechanical clamping effectively result in increased cycle times, increased waste and improper ergonomics for the molding worker.

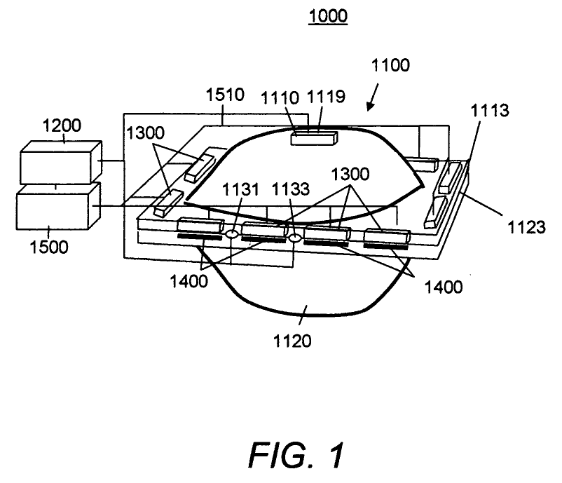

FIG. 1 is a perspective overall view of one embodiment of a magnetic mold closure system 1000 according to the present invention. A magnetic mold closure 1100 employs two mold parts 1110 and 1120 which enclose a cavity for the casting of objects from liquid or semi-liquid mold materials.

Each mold part 1110, 1120 has at least one mating edge 1113, 1123, respectively housing at least one electromagnetic solenoid 1300 on the first mold part 1110 and a metal structure 1400 which is preferably made of a ferromagnetic material, on the second mold part 1120.

The solenoid 1300 is powered by a bidirectional power controller 1500. The bidirectional power controller 1500 includes modular leads 1510 to provide variable and controllable current to solenoid 1300 of mold part 1110. As current passes through solenoid 1300, solenoid 1300 is magnetically attracted to metal structure 1400 holding mold edge 1113 tightly against mold edge 1123.

The solenoids, metal structures and mating edges are precision ground to allow for a precise seal at the edge where the mold parts meet.

In an alternative embodiment, a temperature adjustment unit 1119 is coupled to the logic unit 1200. Logic unit 1200 operates temperature adjustment unit 1119 to cool or heat mold parts 1110, 1120 to bring them to an optimum curing temperature for this material.

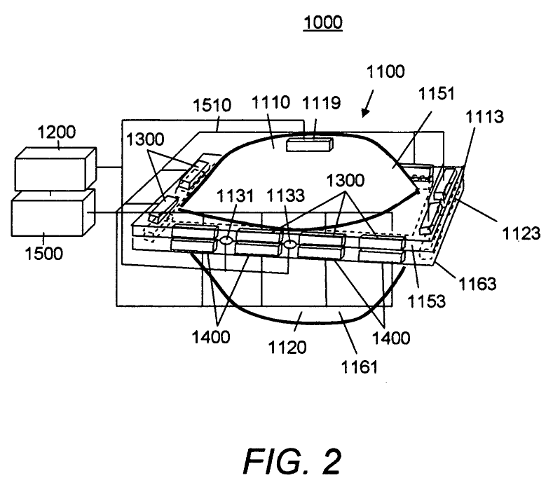

Alternatively, as shown in FIG. 2, there can be a plurality of solenoid 1400 replacing metal structure 1400 on mating edges 1113, 1123 of mold parts 1110, 1120, respectively. By employing a solenoid in place of metal structure 1400, and connecting this solenoid to power controller 1500 one can cause the solenoids to attract each other, or repel each other with a force proportional to the current running through the solenoids 1300, 1400.

A defined current in a reverse direction will cause solenoids 1300 and 1400 to repel each other with a predictable and defined force. Therefore, by adjusting the direction and amount of current, the attraction or repulsion forces between mold parts 1113 and 1123 may be adjusted.

A plurality of sensors 1131 may be employed to detect leakage between mold parts 1110, 1120 which results in flashing. Sensors 1133 may also monitor temperature, viscosity of the material in the mold, pressure, distance between the mold parts 1110, 1120, alignment of the mold parts 1110, 1120 and other properties.

Sensors 1131, 1133 pass their sensed information back to a logic unit 1200. Opening a mold 1100 too early causes the material in the mold to run or droop. Opening the mold too late causes the material to stick to mold parts 1110, 1120.

Logic unit 1200 employs a clock and may be preprogrammed to integrate the temperature over a period of time to determine the optimum time to open the mold 1100.

Also, since the viscosity of the material is very low at the beginning of the molding process, a great deal of force is required to hold the molds together to prevent leakage. This requires a large amount of current. As the material within the mold hardens, it increases viscosity, and progressively less force and current are required to prevent leakage. Therefore, energy is saved by reducing the force and current based upon the sensed viscosity of the material. As a byproduct of this progressive reduction of force, there is less sticking of the material to the mold parts 1110, 1120. Sometimes, the sticking causes the molded object to be destroyed as it is physically removed from the mold enclosure 1100.

Since these molds are used in manufacturing, it is very important to reduce cycling time to increase the manufacturing process efficiency. Since less time is spent trying to remove the molded part from mold enclosure 1100 and less time is spent correcting, or reforming, manufactured objects, there is a direct cost savings.

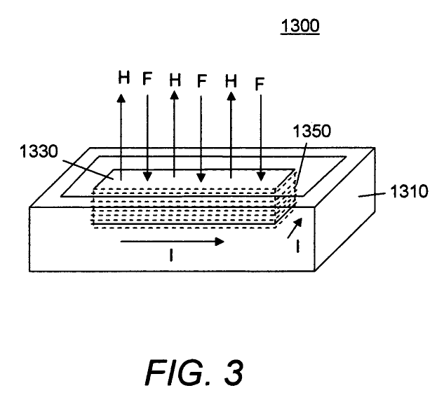

FIG. 3 is an enlarged view of one embodiment of the solenoid 1300, of FIG. 1, or solenoids 1300, 1400 of FIG. 2 according to the present invention. Solenoid 1300, 1400 employs a casing 1310 which has a central core 1330. Typically, this is a ferromagnetic material to increase magnetic flux, shown here as “H”.

The current is provided through coiled wire 1350 which is wrapped around core 1330. As current is provided in the direction marked by “I”, magnetic flux follows the arrows marked “H”. Magnetic force is directed along the flux lines “H” marked by “H”.

Mold parts 1110 and 1120 are designed to fit together minimizing misalignment. Many times they employ a pin or other means for causing the parts 1110 and 1120 to fit together in proper alignment. However, as is common with mechanical parts, there are inherent inconsistencies with manufacturing the molds and inherent manufacturing tolerances.

FIG. 4 is an enlarged view of a cross section of an alternative embodiment of the present invention. In this view mold parts 1110 and 1120 are shown lying horizontally. The mold parts now include an additional overhang 1112, 1122 on the mold parts 1110, 1120, respectively.

Therefore, there may be misalignments and gaps, 1115, 1117, which occur between the mold parts 1110 and 1120. In the case of gap 1115, as described above, solenoids 1300 and 1400 are activated to attract each other and close the gap 1115 between the mold parts in a vertical direction. The magnetic force is proportional to the amount of electrical current provided to solenoids 1300 and 1400.

Similarly, gaps 1117 which occur between overhangs 1112 and 1122 can be adjusted in a horizontal direction by employing solenoids 1700, 1800 on overhangs 1112, 1122. These are powered by a second power source 1600. Logic unit 1200 is connected to sensors 1131, 1133 which determine, among other information, the relative alignment of mold parts 1110, 1120. This information is provided to logic unit 1200.

Logic unit 1200 may now continuously monitor and adjust the alignment between mold parts very accurately, in addition to the functions described above. This causes more accurate molding process, which reduces rework on molded objects, increases efficiency of the molding process and reduces cost per part to manufacture.

In another alternative embodiment of the present invention, mold part 1110 may be comprised of an inner mold part 1151 and an outer frame part 1153 as shown in FIG. 2. A dashed line shows where the outer mold part 1153 overlaps inner mold part 1151.

Mold part 1120 may also be comprised of an inner mold part 1161 and an outer frame 1163. Outer mold parts are shaped like a picture frame with a central opening. The inner mold parts have a lip which is larger than the central opening and are held by the outer mold parts 1153, 1163 as they are clamped together.

This arrangement allows outer mold parts 1153, 1163 having the operational solenoids 1300, 1400 and sensors 1131, 1133 to be removed from the inner mold parts having the shape of the part to be produced.

The outer mold parts 1153, 1163 may then be attached to, or clamp other inner mold parts, to product a different shape.

Since other modifications and changes varied to fit particular operating requirements and environments will be apparent to those skilled in the art, the invention is not considered limited to the example chosen for the purposes of disclosure, and covers all changes and modifications which do not constitute departures from the true spirit and scope of this invention.

What is claimed is:

1. A mold closure 1100 for curing liquid materials into solid objects in said closure comprising:
a) at least two mold parts [1110, 1120] each having mating edges [1113, 1123] which are designed to fit tightly together;
b) At least one electromagnetic solenoid 1300, 1400 on a mold part [1110, 1120] that produces a magnetic field attracting or repelling at least one other mold part [1110, 1120] when provided with an electric current;
c) a logic unit [1200] for determining what forces should be exerted by each solenoid;
d) a bidirectional power controller [1500] responsive to the logic unit 1200 for providing current to the solenoids to provide the force determined by the logic unit [1200] to each of the solenoids.

2. The mold closure of claim 1, further comprising:
a viscosity sensor for measuring viscosity of said material and the logic unit is further adapted to cause the solenoids to attract the other mold part with greater force when the material is less viscous as compared to when the material is more viscous.

3. The mold closure of claim 2, wherein the logic unit is further adapted to sense the measured viscosity of the material from the viscosity sensor and determine that the material has cured enough to be removed from the mold and causes solenoid to force mold parts apart.

4. The mold closure of claim 1, further comprising:
a timer to measure elapsed time to estimate when material is cured enough to be removed from the mold.

5. The mold closure of claim 1, further comprising:
a) a temperature recorder to keep track of the temperature of the material over time, and
b) an integrator which integrates the temperature over time to estimate when the material has cured enough to be removed from the mold.

6. The mold closure of claim 1, further comprising:
At least one permanent magnet on mating edge [1113, 1123] to assist in holding the mold parts [1110, 1120] together.

7. The mold closure of claim 1, further comprising:
a temperature adjustment unit [1119] for bringing the mold parts [1110, 1120] to the optimum curing temperature facilitating curing of the material.

8. The mold closure of claim 1 wherein at least one of the mold parts 1110, 1120 comprises:
an inner mold part 1151, 1161 which is held in place by an outer mold part 1153, 1163.

9. A method of curing a liquid material comprising the steps of:
a) providing a mold having at least two parts,
b) providing an electromagnet on at least one of the mold parts,
c) providing electric current to the electromagnet to hold the mold parts together,
d) filling the mold with the material,
e) estimating when the material has cured, and
f) allowing the mold parts to be released from the material after it has been estimated that the material has cured.

10. The method of curing a liquid material of claim 9 wherein the step of estimating when the material has cured comprises the step of:
sensing when the viscosity of the material has increased above a curing level.

11. The method of curing a liquid material of claim 9 further comprising the steps of:
a) sensing the viscosity of the material and
b) adjusting the electric current based upon the measured viscosity.

12. The method of curing a liquid material of claim 9 wherein the step of estimating when the material has cured comprises the step of:
timing how long the material has been in the mold and comparing that to a predefined time required for curing.

13. The method of curing a liquid material of claim 12 wherein the predefined time for curing is determined for a given ambient temperature.

14. The method of curing a liquid material of claim 9 further comprising the step of:
bringing the material to an optimum curing temperature.
